(19) United States
(12) Patent Application Publication
(10) Pub. No.: US 2023/0390990 A1
(43) Pub. Date: Dec. 7, 2023

(54) Controlled system for manufacturing products

(71) Applicant: SIDEL PARTICIPATIONS, OCTEVILLE-SUR-MER (FR)

(72) Inventors: Mikaël DERRIEN, OCTEVILLE-SUR-MER (FR); Ivan PIERRE, OCTEVILLE-SUR-MER (FR)

(21) Appl. No.: 18/032,008

(22) PCT Filed: Oct. 29, 2021
(86) PCT No.: PCT/EP2020/080174

§ 371 Date: Apr. 14, 2023

(30) Foreign Application Priority Data
Nov. 2, 2020 (FR) FR2011191

(51) Int. Cl. B29C 49/78

(52) U.S. Cl. CPC B29C 49/78; B29C 2049/78805; B29C 2049/78815; B29L 2031/7158

(57) ABSTRACT

Described herein is a system including at least one manufacturing machine that has at least one actuator module, a computer, and a first communication means. The system can also include a remote server that has an information storage means, a second communication means connected to the first communication means by a communication channel. For each product to be manufactured, the system includes at least one identifier and means for reading the identifiers. The means are coupled to the computer, the computer is configured to control the actuator module(s) on the basis of a reading of an identifier carried out by a reading means.

The field of the invention is that of the design and the manufacturing of containers.

More specifically, the invention relates to a controlled system for manufacturing containers by blow-molding or stretch blow-molding.

The containers are made of plastic material and are generally obtained by blow-molding or stretch blow-molding.

For that, preforms made of plastic material are heated beyond a glass transition temperature at which their constituent material is softened enough to allow their deformation and allow containers to be obtained with a desired form.

As in various industrial fields, it is known that dedicated manufacturing parameters are applied to each product to be obtained.

These parameters can be defined theoretically and automatically, or specifically by one or more engineers or technicians for example.

When the engineers or technicians have to define said parameters, they use information linked to the product to be obtained such as, for example, drawings, digital models, production rates to be observed or even recommendations from suppliers of raw materials for example.

All this information must then be collected by the engineers or technicians for it to be subsequently used for the definition of the manufacturing parameters.

However, such collection of the parameters, and the subsequent processing thereof, demand working time of the technicians or engineers.

In the context of obtaining containers from preforms made of plastic material, certain parameters differ to obtain containers of different forms.

As an example, such is the case with the preform heating parameters which are notably defined on the basis of the plastic material of the preform (supplier recommendations), of the form of the container to be obtained (digital model and/or drawings) or even of the requirement of the final customer (production rates to be observed).

Indeed, to obtain containers that are cylindrical of revolution, the heating of the preform will be identical over its entire periphery.

On the other hand, to obtain containers exhibiting reliefs or localized patterns, a selected heating of the periphery of the preform is performed, alternating so-called hot zones and so-called cold zones, that is to say zones of different temperatures.

This type of heating is notably known as preferential heating.

Moreover, when the size of the containers to be obtained is changed, several parameters of the manufacturing machine must be updated.

Conventionally, these parameters are updated by an operator who is dedicated to setting the manufacturing machines.

However, the need for a dedicated operator is not without drawbacks.

Indeed, the parameterizing of a machine can be lengthy and tedious for an operator.

Furthermore, there is a risk, when the parameters are updated, of the operator committing an error when inputting the new parameters.

For that, a check by a second operator may be provided. However, such a check brings with it a significant cost and mobilizes a second resource who could be assigned to another task.

Finally, when several manufacturing machines are to be updated for manufacturing of one and the same product, the time to update the production parameters can prove lengthy for all of the manufacturing system, that is to say for all of the production machines.

The objective of the invention is notably to mitigate the abovementioned drawbacks of the prior art.

More specifically, the objective of the invention is to propose a solution that makes it possible to make the machine setting phases more reliable and faster.

Also an objective of the invention is to provide such a solution which is simple to implement and allows an operator, technician or engineer to obtain information concerning a machine or a manufacturing method rapidly and safely.

A further objective of the invention is to provide such a solution which makes it possible to update an internal database, reliably.

These objectives, and others which will emerge hereinbelow, are achieved by virtue of the invention, the subject of which is a system comprising at least one manufacturing machine including:
at least one actuator module;
a computer;
first communication means;
the system also comprising a remote server including:
means for storing information on a manufacturing method to be implemented by the manufacturing machine or relating to a product to be manufactured by the manufacturing machine;
second communication means linked to the first communication means by a communication channel,
characterized in that the system comprises, for each product to be manufactured, at least one identifier,
and in that the storage means incorporate a database mapping said identifiers with the information of said product,
and in that the system also comprises reading means for reading said identifiers, coupled to the computer
and in that the computer is parameterized to retrieve, via said communication channel and on the basis of a reading of an identifier performed by the reading means, the information corresponding to the identifier, in order to control the actuator module or modules on the basis of said retrieved information, and/or consult information linked to said product to be manufactured and/or to the manufacturing machine.

Such a system makes it possible to facilitate the manufacturing of products via the manufacturing machine since it is not necessary for a manufacturing operator to manually enter identification parameters concerning products to be manufactured. Thus, this makes the manufacturing process more reliable and also makes it possible to make more reliable and facilitate the aid to defining the product manufacturing parameters.

Indeed, by the simple reading of an identifier, it is possible to instantaneously download, from the remote server, into the manufacturing machine, information linked to the manufacturing or to the product to be manufactured.

Moreover, in the case of the manufacturing of one and the same product by several different machines, it is possible to ensure that each of the machines does indeed contain the correct manufacturing information since this information is inserted into the machine automatically by the reading of the identifier.

Thus, that avoids the human errors linked to the manual inputting of the manufacturing information that can be subject to errors when entered manually for example by a reading fault on the part of the operator or by a typing error on a keyboard.

Finally, the consulting of the manufacturing information can be done at any time by a simple connection to the remote server, which makes it possible to check that the machine settings are correct or even to obtain additional information on the product to be manufactured.

In other words, the identifier can allow access to information not contained on the medium of the identifier, such as, for example, a digital module of the product which will be manufactured, such a digital module not being able to be displayable by a medium such as a hardcopy drawing.

Advantageously, the system also comprise computing units coupled to the remote server to transit to the remote server and/or update the information stored, or to be stored, in the storage means.

The use of computing units allows remote people, notably suppliers of raw materials or development engineers, to be able to make modifications to a machine being operated by a manufacturer. Indeed, in the context of the manufacturing of containers made of plastic material by blow-molding or stretch blow-molding, the manufacturing machines are developed then installed at an industrial facility, a producer of liquid products for example, which itself manufactures its containers to fill them immediately with the product that it also manufacturers.

Thus, in the case of modifications to be made to these containers to be manufactured, the developers of the machine can, if necessary, modify the information to be incorporated to proceed with the manufacturing remotely, so that, when the manufacturer wants to manufacture its containers, the updates are already made without the prior intervention of a specialist technician having to visit the manufacturing site.

Preferably, the system also comprises computing devices coupled to the computer of the machine and intended to receive at least a part of the information stored in the storage means of the remote server.

The computing devices make it possible to obtain knowledge of the information contained in the remote server to be able to use it if applicable or simply consult it, either directly on the machine, for example when it is a screen of touch type, or in a roaming manner for example, when it is a smartphone or a digital tablet.

According to an advantageous embodiment, the identifiers are of QR code or barcode type.

Such identifiers are relatively compact and make it possible to return a plurality of information while being each associated with a single manufactured product.

According to another advantageous embodiment, the identifiers are of NFC or RFID type.

Such electronic chips are passive and allow communication and an exchange of information simply while offering a memory for possible storage of certain information.

Preferentially, the information stored in the storage means for each container is of at least one of the following types:
digital drawings of the product to be manufactured;
setting parameters of the manufacturing machine;
program controlling actuator modules of the manufacturing machine;
information on series production of a product.

Such types of information make it possible to know the dimensional characteristics of a product to be manufactured, or even be able to set the machine either automatically without human intervention, or by a check on the information entered manually by an operator.

According to a preferred aspect, the products to be manufactured are of the type of containers made of plastic material obtained by a blow-molding or stretch blow-molding method.

The manufacturing of containers of plastic material by blow-molding or stretch blow-molding demands very precise manufacturing parameters which can, in case of error, be detrimental to the correct manufacturing of the containers or provoke the manufacturing of containers exhibiting defects.

It is therefore necessary, when one and the same product, that is to say one and the same container, is manufactured on several different manufacturing machines, for each machine to have the same settings, or virtually the same settings, in order to guarantee a uniform manufacturing of the containers on each machine.

That is possible by virtue of the system according to the invention since the human errors are limited, even eliminated, between two machines intended to manufacture identical products.

Thus, a correction made to the information will make it possible to modify and correct the errors observed on all the manufacturing machines, simultaneously.

Advantageously, the identifier is borne by a drawing of hardcopy type presenting a definition of the product to be manufactured.

The use of a drawing of hardcopy type to bear the identifier allows a user or a manufacturing operator to be able to identify, simply by looking at the drawing, that the product to be manufactured does indeed conform to its expectations. Indeed, the manufacturing operator can identify the product that he or she must manufacture from among several different products and load into the manufacturing machine the parameters and the information necessary to the correct manufacturing, simply by presenting the identifier to the reading means of the machine.

Preferably, the identifier is a symbol and/or an electronic chip.

The invention also relates to a method for manufacturing a product by means of a system as previously described, this method comprising the steps consisting mainly of:
reading an identifier by the reading means;
retrieving, via the communication channel, the information corresponding to the identifier, by means of the computer;
controlling the actuator modules of the manufacturing machine on the basis of the information retrieved by the computer.

Such a method makes it possible to facilitate the manufacturing of products since the setting or setting checking steps, or even the step of consulting information concerning the product which will be manufactured, can be performed remotely, if necessary automatically and rapidly without requiring human intervention.

Preferably, the method also comprises a step consisting in updating the information contained in the storage means of the remote server by means of at least one computing unit.

The quality of the products obtained can then be improved since the information linked to the product to be manufactured can be updated remotely then loaded into the manufacturing machine at the required time, that being done automatically and, if applicable, without human intervention apart from launching the loading of the data by reading the identifier.

Other features and advantages of the invention will become more clearly apparent on reading the following description of a preferential embodiment of the invention, given as an illustrative and nonlimiting example, and the attached drawings in which:

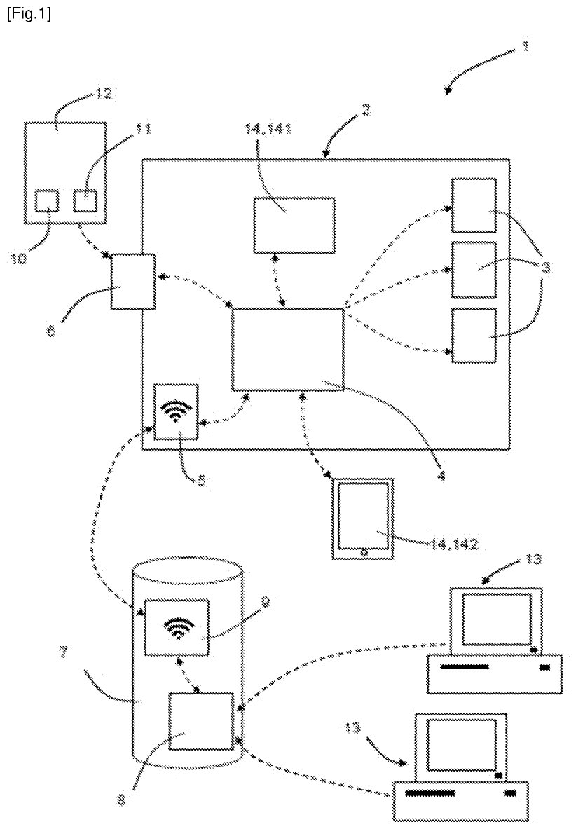

FIG. 1 is a schematic representation of a system according to the invention;

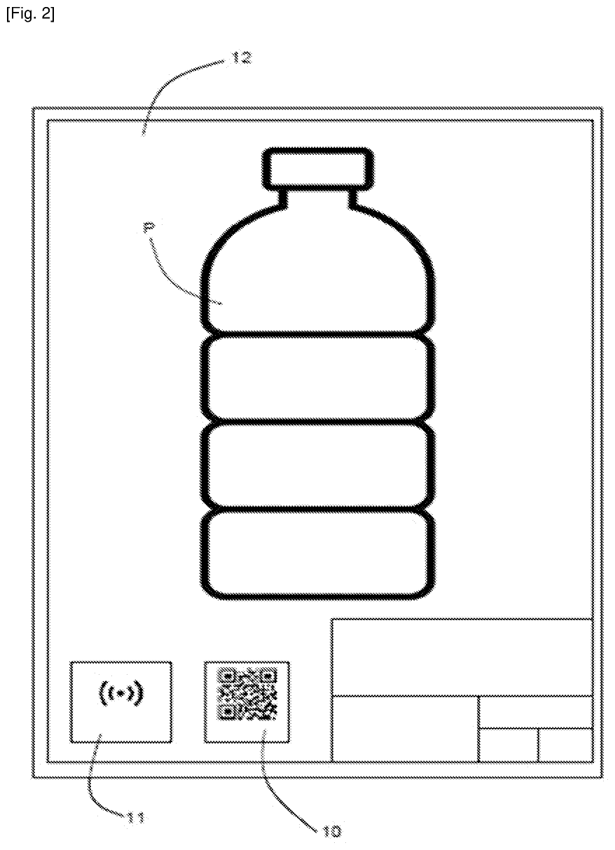

FIG. 2 is a schematic representation of a drawing of a product to be manufactured by means of the system of FIG. 1, this drawing comprising an identifier allowing said product to be manufactured;

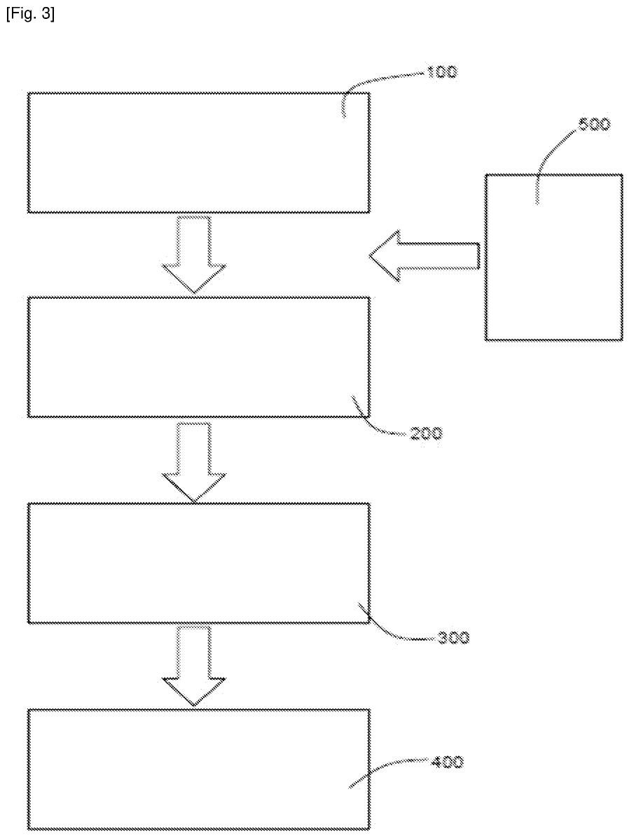

FIG. 3 is a schematic representation of a flow diagram of a method for producing or manufacturing a product by means of the system according to FIG. 1.

FIG. 1 illustrates a system 1 for manufacturing products P, according to the invention.

This system 1 comprises at least one manufacturing machine 2 including:
at least one actuator module 3;
a computer 4;
first communication means 5.

The system 1 also comprises reading means 6.

These reading means 6 are preferentially incorporated in the manufacturing machine 2.

In a variant, the reading means 6 are roaming and for example take the form of an optical sensor incorporated in a mobile electronic device of smartphone or digital tablet type.

The reading means 6 are advantageously of analog type.

The system 1 also comprises a remote server 7 including:
information storage means 8;
second communication means 9.

Preferably, the information stored in the storage means 8 relate to a manufacturing method to be implemented by the manufacturing machine 2 or information relating to a product P to be manufactured by the manufacturing machine 2.

The second communication means 9 are intended to cooperate with the first communication means 5 of the manufacturing machine 2, as explained hereinbelow.

The system 1 according to the invention comprises, for each product P to be manufactured, an identifier taking the form of a symbol 10 and/or an electronic chip 11 associated with said product P to be manufactured.

More particularly, this symbol 10 and/or electronic chip 11 is borne by a drawing 12 of hardcopy type showing a definition of the product P.

Such a product P to be manufactured is, for example, a container made of plastic material obtained by a blow-molding or stretch blow-molding method.

The drawing 12, for example a sheet notably in A4 or A3 format, can bear, in one corner, as is illustrated in FIG. 2, either a symbol 10 of QR code or barcode type for example, or an electronic chip 11 of NFC (acronym for near field communication) or RFID (acronym for radio frequency identification) type.

According to another embodiment not illustrated in the figures, the support of the identifier is a reproduction of the product which will be manufactured.

The identifier, that is to say the symbol 10 or the electronic chip 11 is intended to be read by the reading means 6 of the manufacturing machine 2.

For that, the storage means 8 incorporate a database mapping the symbols 10 and/or electronic chips 11 with the information of said product P.

Indeed, as explained hereinbelow, by the reading of the symbol 10 or of the electronic chip 11, manufacturing information or information concerning the product P to be manufactured is retrieved from the database of the storage means 8 in order to be able to set up the manufacturing of said product P or allow an operator, technician or engineer to use or consult information linked to the product P.

This information is, by way of illustrative and nonlimiting example, digital drawings of the product P to be manufactured, setting parameters of the manufacturing machine 2, or even information on series production of the product P.

Other types of information can also be obtained by the reading of the symbol 10 or of the electronic chip 11.

For that, the reading means 6 of the manufacturing machine 2 are coupled to the computer 4.

The computer 4 is then parameterized to identify an open communication channel between the first communication means 5 of the manufacturing machine 2 and the second communication means 9 of the remote server 7, based on a reading of a symbol 10 and/or of an electronic chip 11, and retrieve, via said open communication channel, the information corresponding to the symbol 10 and/or to the electronic chip 11.

The retrieved information can for example make it possible to set the actuator module or modules 3 of the manufacturing machine 2.

Indeed, the retrieved information can notably comprise a program controlling the actuator modules 3 of the manufacturing machine 2.

Consequently, it is possible for an operator to initiate a manufacturing cycle by the simple reading of the symbol 10 or of the electronic chip 11, the manufacturing machine 2 then being controlled by the computer 4 and more particularly according to the program retrieved by the computer 4.

The system 1 also comprises computing units 13 coupled to the remote server 7 to transmit, to the remote server 7, and/or update, the information stored or to be stored in the storage means 8.

Thus, manufacturers of raw materials or even designers can transmit information to the remote server 7, this information being able to be characteristics of the product which will be manufactured or setting information for the manufacturing machine 2.

As an example, the update of the content of the storage means 8 can relate to a modification of the manufacturing method to make it more efficient for example, or a modification of the form of the product P to be manufactured which can possibly change the manufacturing parameters of the manufacturing machine 2.

The system 1 also comprises computing devices 14 coupled to the computer 4 of the manufacturing machine 2 and intended to receive at least a part of the information stored in the storage means 8 of the remote server 7.

As an example, these computing devices 14 can take the form of a screen 141, touch or otherwise, permanently mounted on the manufacturing machine 2, or even a smartphone or a digital tablet 142, and form roaming objects owned by operators involved in the manufacturing cycle of a product P.

That notably makes it possible, for a manufacturing engineer, to obtain knowledge of the manufacturing parameters, and for example check the parameters of the manufacturing machine 2.

The manufacturing of a product P by means of the system 1 previously described is performed according to the method comprising the steps described hereinbelow.

Referring to FIG. 3, the method comprises a first step 100 consisting in reading a symbol 10 and/or an electronic chip 11 via the reading means 6 of the manufacturing machine 2.

A second step 200 consists in identifying, by the computer 4, a communication channel between the first communication means 5 and the second communication means 9.

The method comprises a third step 300 consisting in retrieving, on the manufacturing machine 2, via said open communication channel, the information corresponding to the identifier, by means of the computer 4 of the manufacturing machine 2.

The database of the storage means 8 maps said identifiers borne by each of the drawings 12 with the information on products P contained in the storage means 8.

The method comprises a fourth step 400 consisting in controlling the actuator modules 3 of the manufacturing machine 2 on the basis of the information retrieved by the computer 4.

Furthermore, the manufacturing method also comprises a fifth step 500 consisting in updating the information contained in the storage means 8 of the remote server 7 by means of at least one computing unit 13.

This fifth step is optional and makes it possible, if applicable, to modify the information contained in the remote server 7, notably for updating it or adding new information to it.

Information can also be deleted, notably when a product P is no longer manufactured.

The system 1 for manufacturing products P and the method which have just been described make it possible to manufacture products P easily, notably by virtue of the fact that a production operator or engineer simply has to read the symbol 10 or the electronic chip 11 by the reading means 6 to load, automatically, a manufacturing program, manufacturing data, or even characteristics of the product, which make it possible to perform the manufacturing of the products P in total safety.

Furthermore, for the updates via the computing units 13, it is possible, simply and rapidly, to update a method for manufacturing a product or obtain information on any product P.

Moreover, that makes it possible to smooth the manufacturing methods and the exchanges between the various people involved, notably between the manufacturer and the suppliers of raw materials, while preventing the risk of error since, when the information is entered in the server, provided that it has been checked and that it is correct, all the manufacturing machines 2 invoking this information will be able to properly manufacture the product P.

Thus, unless a change of parameters is performed deliberately by a production agent on one of the manufacturing machines 2, all the manufacturing machines 2 will produce products P according to identical manufacturing parameters and set points.

Furthermore, that makes it possible to guarantee the manufacture of identical products P on different manufacturing machines 2, since each manufacturing machine invokes the same manufacturing information and the latter is not entered manually by an operator, which limits the risks of human error and guarantees a manufacturing of products P in accordance with preestablished criteria.

It should also be noted that the symbol 10 or the electronic chip 11 can allow access to information that a simple 2D medium cannot contain, such as, for example, access via a server to computing files allowing the 3D printing of models corresponding to the products to be manufactured.

The symbol 10 or the electronic chip 11 can also be encrypted and allow access to the abovementioned information, contained on a server, only for a user having an identifier and a password that are recognized. That therefore makes it possible to offer services that a simple 2D drawing cannot offer, and can allow connectivity of several machines via a dedicated network.

1. A system (1) comprising at least one manufacturing machine (2), the manufacturing machine comprising:
at least one actuator module (3);
a computer (4); and
a first communication means (5);
wherein the system also comprises a remote server (7), the remoter server (7) comprising:
a means (8) for storing information, wherein the information relates to a manufacturing method to be implemented by the manufacturing machine (2) or relates to a product (P) to be manufactured by the manufacturing machine (2);
a second communication means (9) linked to the first communication means (5) by a communication channel;
wherein the system (1) comprises, for each product (P) to be manufactured, at least one identifier;
wherein the storage means (8) incorporates a database mapping said identifiers with the information of said product (P);
wherein the system (1) further comprises a reading means (6) for reading said identifiers, coupled to the computer (4); and
wherein the computer (4) is parameterized to retrieve, via said communication channel and on the basis of a reading of the identifier performed by the reading means (6), the information corresponding to the identifier, in order to control the actuator module or modules (3) on the basis of said retrieved information and/or consult information linked to said product (P) to be manufactured and/or to the manufacturing machine (2).

2. The system (1) as claimed in claim 1, further comprising computing units (13) coupled to the remote server (7) to transmit to the remote server (7) and/or update the information stored, or to be stored, in the storage means (8).

3. The system (1) as claimed in claim 1, further comprising at least one computing device (14) coupled to the computer (4) of the manufacturing machine (2), wherein the computing device (14) receives at least a part of the information stored in the storage means (8) of the remote server (7).

4. The system (1) as claimed in claim 1, where the identifiers are a QR code or a barcode.

5. The system (1) as claimed in claim 1, wherein the identifiers are an NFC or an RFID.

6. The system (1) as claimed in claim 1, wherein the information contained in the storage means (8) for each container is selected from at least one of the following types:
a digital drawing of the product (P) to be manufactured;
a setting parameter of the manufacturing machine (2);
a program controlling the actuator modules (3) of the manufacturing machine (2); and
information on series production of the product (P).

7. The system (1) as claimed claim 1, wherein the products (P) to be manufactured are of the type of containers made of plastic material obtained by a blow-molding or stretch blow-molding method.

8. The system (1) as claimed in claim 1, the identifier is borne by a drawing (12) of hardcopy type presenting a definition of the product (P) to be manufactured.

9. The system (1) as claimed in claim 1, wherein the identifier is a symbol (10), an electronic chip (11), or both.

10. A method for manufacturing a product by means of a system (1) according to claim 1, wherein the method comprises:
reading an identifier by a reading means (6);
retrieving, a the communication channel, information corresponding to the identifier, by means of a computer (4); and
controlling actuator modules (3) of the manufacturing machine (2) via the information retrieved by the computer (4).

11. The method for manufacturing a product as claimed in 1, further comprising a step of updating the information contained in a storage means (8) of a remote server (7) by at least one computer unit (13).
